(19) United States
(12) Patent Application Publication
(10) Pub. No.: US 2005/0217776 A1
(43) Pub. Date: Oct. 6, 2005

(54) Wheel rim with tire anti-breaking anti-knocking protection

(76) Inventor: Yueh Nu Chen, I Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/834,910

(22) Filed: Apr. 30, 2004

(30) Foreign Application Priority Data
Apr. 1, 2004 (TW) 093109100

(51) Int. Cl. B60C 15/06

(52) U.S. Cl. 152/381.6

(57) ABSTRACT

A wheel rim is constructed to include a wheel rim body holding a tire, and a supplementary tire support mounted on a flange around the periphery of the wheel rim body for supporting the tire for enabling the car to run to a repair shop in case the tire is broken during running.

### BACKGROUND OF THE INVENTION

1. Field of the Invention

The present invention relates generally to a wheel rim and more particularly, to a wheel rim with tire anti-breaking anti-knocking protection.

2. Description of the Related Art

When the tire of a vehicle wheel is inflated, high-pressure air supports the tire in shape for running on the road. If a pointed body pierced the tire, the broken tire becomes unable to support the vehicle wheel for normal running on the road, and the broken tire must be repaired immediately. However, It is dangerous if one of the wheels of a vehicle is broken during a high speed running.

### SUMMARY OF THE INVENTION

The present invention has been accomplished under the circumstances in view. It is the main object of the present invention to provide a wheel rim for vehicle tire, which supports the tire in shape for enabling the car to run to a repair shop in case the tire is broken during running. To achieve this and other objects of the present invention, the wheel rim comprises a wheel rim body holding a tire, the wheel rim body having a flange extended around the periphery thereof on the middle, and a supplementary tire support mounted on the flange of the wheel rim body and adapted to support the tire in shape in case the tire is broken during running. The supplementary tire support is comprised of a plurality of joint blocks, a plurality of links that connect the joint blocks in series, and two end connecting members that join the ends of the series of joint blocks:

### BRIEF DESCRIPTION OF THE DRAWINGS

FIG. 1 is a cross sectional view of the preferred embodiment of the present invention.

FIG. 1A is an exploded view of a joint block according to the present invention.

FIG. 2 is an exploded view of a part of a supplementary tire support according to the present invention.

FIG. 3 is an exploded view of another part of the supplementary tire support according to the present invention.

FIG. 4 is a cross sectional view of a vehicle wheel constructed according to the present invention.

FIG. 5 is a schematic drawing showing the broken tire supported on the supplementary tire support around the wheel rim according to the present invention.

### DETAILED DESCRIPTION OF THE INVENTION

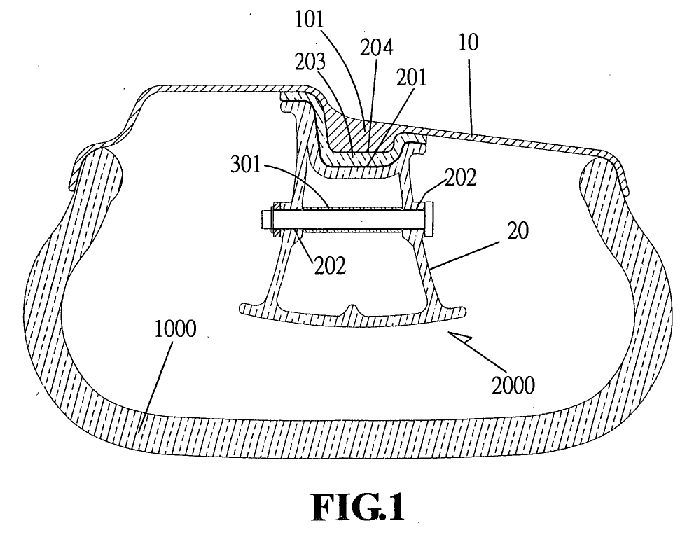

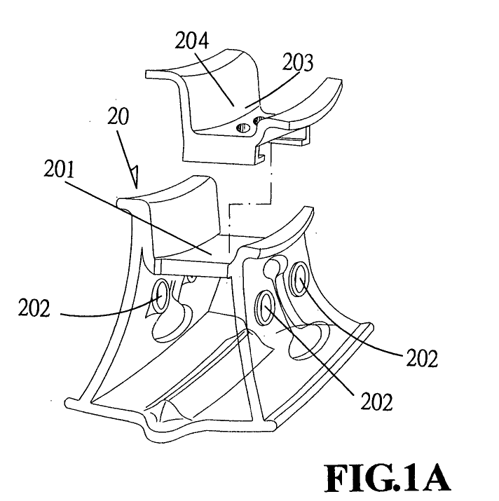

Referring to FIGS. 1˜4, a wheel rim with tire anti-knocking anti-breaking protection in accordance with the present invention is shown comprised of a wheel rim body 10, and a supplementary tire support 200 mounted around the periphery of the wheel rim body 10. The supplementary tire support 200 is comprised of a plurality of joint blocks 20, a plurality of links 30, a first end connecting member 40, a second end connecting member 40a, and a screw bolt 50.

The wheel rim body 10 comprises a flange 101 extended around the periphery on the middle (see FIG. 1). The cross section of the flange 101 can be made having any of a variety of shapes.

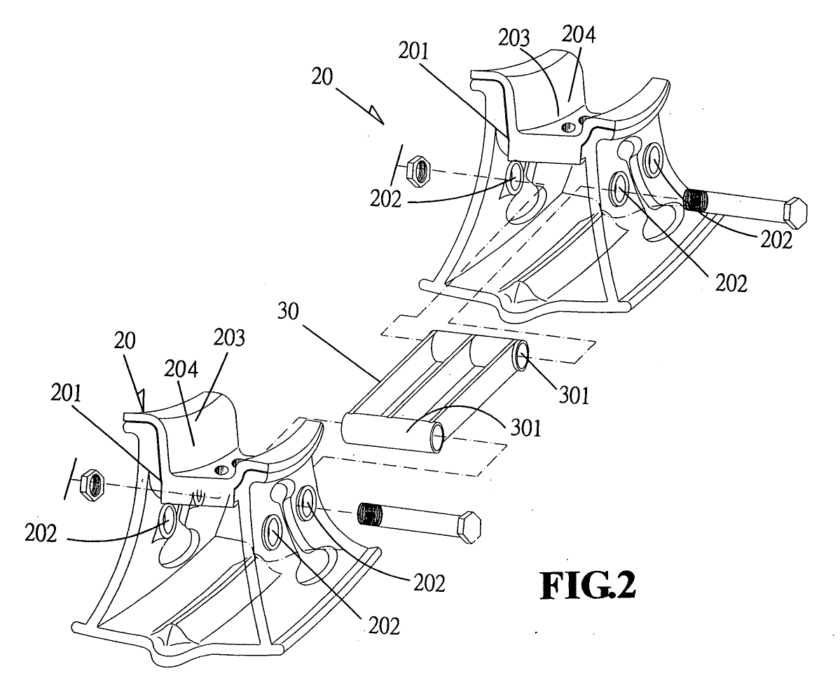

The joint blocks 20 are hollow block members (see FIGS. 1A and 2), each having a top recess 201 fixedly mounted with a packing pad 203, and two pairs of through holes 202 axially aligned at two opposite lateral sides. The packing pad 203 has a recessed portion 204 fitting the flange 101 of the wheel rim body 10.

The links 30 connect the joint blocks 20 in series, each comprising two barrels 301 transversely disposed at two ends (see FIG. 2).

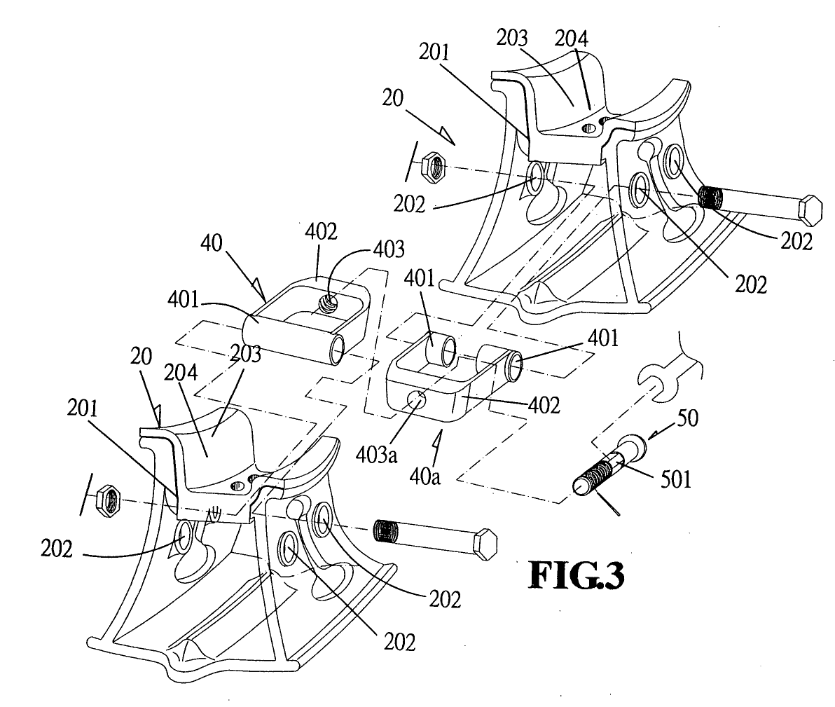

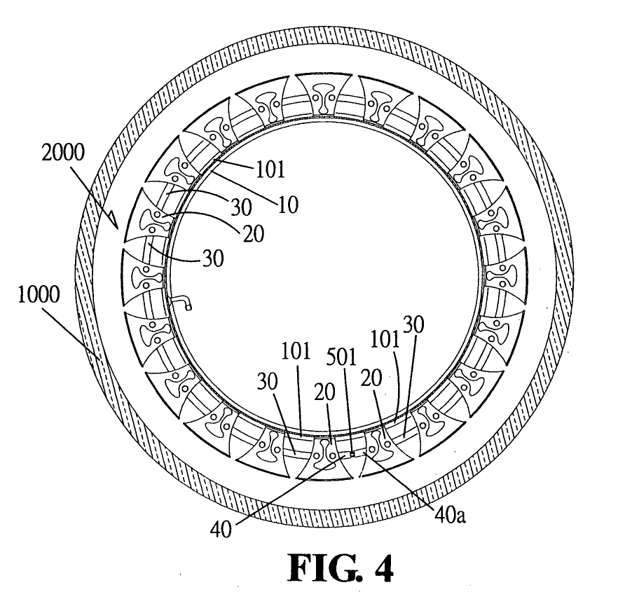

The first end connecting member 40 and the second end connecting member 40a are connected together to join the ends of the series of joint blocks 20 (see FIG. 4). The first end connecting member 40 comprises a U-shaped base frame 402, a transverse barrel 401 connected to the ends of the U-shaped base frame 402, and a screw hole 403 extended through a middle part of the U-shaped base frame 402 (see FIG. 3). The second end connecting member 40a comprises a U-shaped base frame 402, two barrels 401 respectively connected to the ends of the U-shaped base frame 402, and a through hole 403a extended through a middle part of the U-shaped base frame 402 (see FIG. 3).

The screw bolt 50 is inserted through the through hole 403a of the second end connecting member 40a and threaded into the screw hole 403 of the first end connecting member 40 to secure the first end connecting member 40 and the second end connecting member 40a together, having a polygonal shoulder 501 for the grasping of a wrench or the like that is used to drive the screw bolt 50 into the screw hole 403 of the first end connecting member 40 (see FIG. 3).

Referring to FIGS. 1˜4 again, by means of connecting the barrels 301 of the links 30 and the barrels 401 of the end connecting members 40;40a to the through holes 202 of the joint blocks 20 with screw bolts, the rim support 200 and the joint blocks 20 with the links 30 and the end connecting members 40;40a are fastened together, thereby forming the desired supplementary tire support 2000 around the periphery of the wheel rim body 10 within the tire 1000.

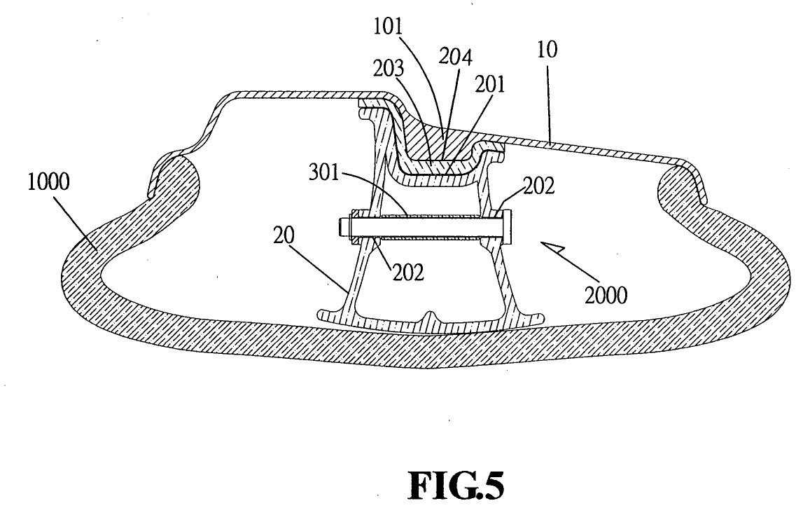

Referring to FIG. 5, when the tire 1000 is broken, the supplementary tire support 2000 support the broken tire 1000, enabling the driver to drive the car to a vehicle repair shop for repair.

Although a particular embodiment of the invention has been described in detail for purposes of illustration, various modifications and enhancements may be made without departing from the spirit and scope of the invention. Accordingly, the invention is not to be limited except as by the appended claims.

1. A wheel rim comprising a wheel rim body holding a tire, said wheel rim body comprising a flange extended around the periphery thereof on the middle, and a supplementary tire support mounted on said flange of said wheel rim body and adapted to support said tire in shape in case said tire is broken during running, said supplementary tire support comprising:
a plurality of joint blocks, said joint blocks each having a top recess fixedly mounted with a packing pad that fits over said flange of said wheel rim body, and two pairs of through holes axially aligned at two opposite lateral sides thereof;
a plurality of links adapted to connect said joint blocks into a series of joint blocks, said links each having two barrels transversely disposed at two ends thereof and connectable to the through holes of said joint blocks with screw bolts;
a first end connecting member and a second end connecting member adapted to join the ends of said series of joint blocks, said first end connecting member and said second end connecting members each comprising a U-shaped base frame and at least one transverse barrel connected to two distal ends of said U-shaped base frame and connectable to the through holes of said joint blocks with screw bolts, said U-shaped base frame having a mounting hole on the middle, the mounting hole of the U-shaped base frame of said first end connecting member being connected to the mounting hole of the U-shaped base frame of said second end connecting member with a screw bolt.
